(19) United States
(12) Patent Application Publication
(10) Pub. No.: US 2024/0126354 A1
(43) Pub. Date: Apr. 18, 2024

(54) POWER BUDGETING FOR COMPUTER PERIPHERALS

(71) Applicant: Intel Corporation, Santa Clara, CA (US)

(72) Inventors: Kunal Shah, Bangalore (IN); Prabhakar Subrahmanyam, San Jose, CA (US); Venkataramani Gopalakrishnan, Folsom, CA (US); Chuen Ming Tan, Bayan Lepas (MY); Venkataramana Kotakonda, Bengaluru (IN); Mitsu Shah, Bangalore (IN); Kannappan Rajaraman, Bangalore (IN); Yi Jen Huang, Portland, OR (US); Dmitriy Berchanskiy, Rocklin, CA (US); Swathi Nukala, Portland, OR (US)

(21) Appl. No.: 18/399,224

(22) Filed: Dec. 28, 2023

(51) Int. Cl. G06F 1/26; G06F 1/3203

(52) U.S. Cl. CPC G06F 1/266; G06F 1/3203

(57) ABSTRACT

Systems, apparatus, articles of manufacture, and methods are disclosed for power budgeting for computer peripherals with electronic devices. An example apparatus to budget power in an electronic device includes interface circuitry; machine readable instructions; and programmable circuitry to at least one of instantiate or execute the machine readable instructions to: detect a Type-C event associated with a computer peripheral; write a power level offset based on an assumed power contract for the computer peripheral during debounce time; obtain an actual power contract for the computer peripheral; and adjust the power level offset based on the actual power contract.

### FIELD OF THE DISCLOSURE

This disclosure relates generally to electronic devices and, more particularly, to power budgeting for computer peripherals.

### BACKGROUND

When a computer peripheral is connected to an electronic device, the computer peripheral draws power. The power draw increases the workload on the battery of the electronic device.

### BRIEF DESCRIPTION OF THE DRAWINGS

FIG. 1 is an illustration of an example electronic device with example computer peripherals.

FIG. 2 is a block diagram of an example implementation of the electronic device of FIG. 1 including example power budget circuitry.

FIG. 3 is an example timing chart during connection of a computer peripheral to the electronic device.

FIGS. 4 and 5 are flowcharts representative of example machine readable instructions and/or example operations that may be executed, instantiated, and/or performed by example programmable circuitry to implement the power budget circuitry and the electronic device of FIG. 1.

FIG. 6 is a block diagram of an example processing platform including programmable circuitry structured to execute, instantiate, and/or perform the example machine readable instructions and/or perform the example operations of FIGS. 4 and 5 to implement the power budget circuitry of FIG. 2.

FIG. 7 is a block diagram of an example implementation of the programmable circuitry of FIG. 6.

FIG. 8 is a block diagram of another example implementation of the programmable circuitry of FIG. 6.

In general, the same reference numbers will be used throughout the drawing(s) and accompanying written description to refer to the same or like parts. The figures are not necessarily to scale. Instead, the thickness of the layers or regions may be enlarged in the drawings.

### DETAILED DESCRIPTION

Electronic device are often coupled (e.g., via wired or wireless connections) to one or more computer peripherals to facilitate the transmission and reception of communications and data between the devices. Computer peripherals include, for example, an external storage devices (e.g., a hard disk drive, a thumb drive, a flash drive, etc.), a mobile device (e.g., a smartphone, a tablet, etc.), a speaker, a light, a mouse, a keyboard, a webcam, a monitor, a microphone, a scanner, a printer, a pen, a fan, a virtual reality device, a joystick, headphones, and/or other types of input devices, output devices, and/or storage devices.

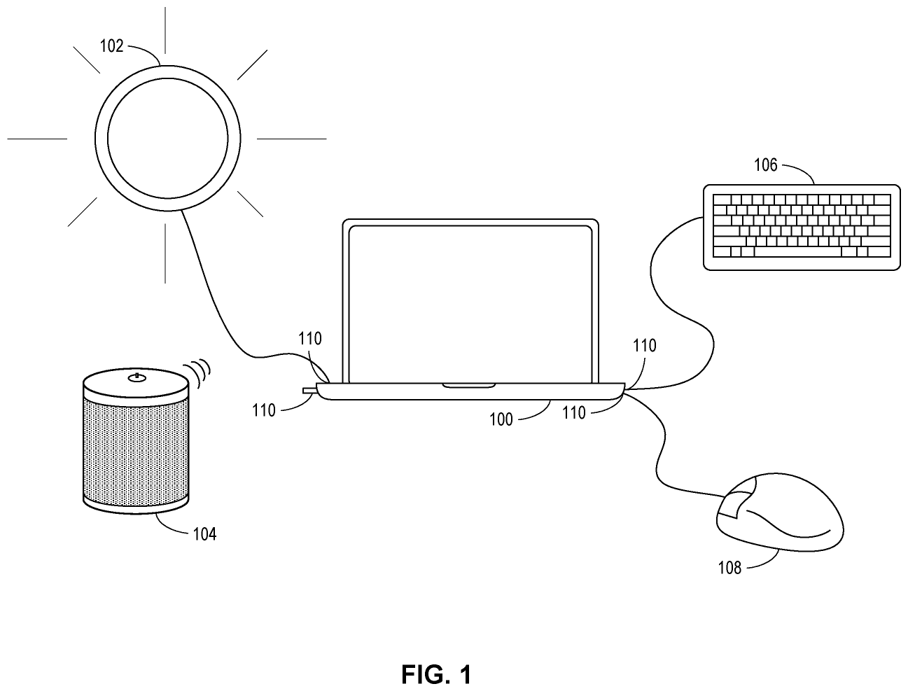

FIG. 1 shows an example electronic device 100 coupled to a plurality of example computer peripherals such as an example light 102, an example speaker 104, an example keyboard 106, and an example mouse 108. In other examples, additional, fewer, different, and/or duplicates ones of the computer peripherals may be coupled to the electronic device 100. In the illustrated example, the computer peripherals are coupled to the electronic device 100 via a wired or wireless connection to connector port 110 such as, for example, a universal serial bus (USB) port.

The universal serial bus (USB) standard is a standard that defines cables, connections, and communication protocols used for connection, communication, and power supply between electronic devices. The USB standard utilizes different connector types. An example of these USB standards is the USB Type-C standard that defines a reversible plug connector for USB devices. The Type-C plug connects to electronic devices and computer peripherals that function as both hosts and connected devices. USB Type-C connectors can support power and data exchange in a single cable or connector that is coupled to a Type-C port on the electronic device.

Computer peripherals draw power from the electronic device and, therefore, increase the workload on a battery of the electronic device. Peak workloads can crash battery operated electronic devices when the power drawn exceeds that of battery capability. Power budgeting is based on an estimation of the expected power to be consumed by the components of the electronic device and the computer peripherals. Not budgeting power for computer peripherals (e.g., Type-C devices) risks stressing the battery. Power budgeting between the central processing unit (CPU) of the electronic device, other components of the electronic device, and the computer peripherals ensures that the system draws power within the capability of the battery.

When the power budgeting for the Type-C ports is done based on the number of available ports and is static, the power budgeting estimate may be inaccurate. With a static power budget, even when no computer peripherals are connected to the Type-C ports, the same power budget is assigned for the Type-C ports. This results in poor performance of the electronic device as the expected power consumed has been overbudgeted, leaving less power for the central processing unit (CPU) and/or other components of the electronic device. For example, a laptop may have a peak power setting at 80 Watts (W) due to battery limitation. If this laptop has three Type-C ports, a static power budgeting may reserve 15 W per port, regardless of whether a computer peripheral is attached to any one of the Type-C ports. 15 W per port is subtracted from the available 80 W peak power, leaving only 35 W for the CPU to use during a peak power setting. In such an example, CPU operation will likely be interrupted during peak power usage.

Examples disclosed herein implement dynamic power budgeting during attachment of a Type-C USB device, detachment of a Type-C USB device, and/or different power transition events at a Type-C USB connector (collectively referred to as “Type-C events”). Example dynamic power budgeting disclosed herein does not sacrifice the user experience and avoids battery overloads.

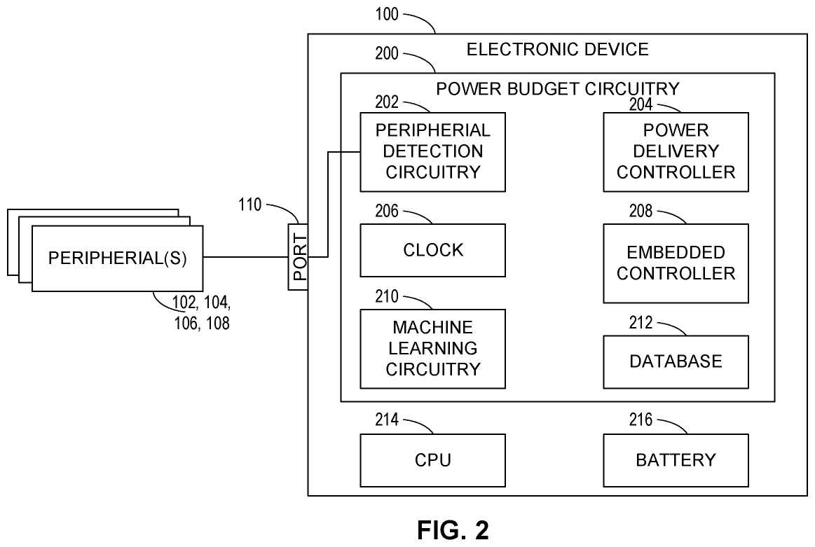

FIG. 2 is a block diagram of an example implementation of the electronic device 100 of FIG. 1 coupled to the computer peripherals 102, 104, 106, 108 via the USB port 110. The computer peripherals 102, 104, 106, 108 are coupled through separate connector ports 110, though only one connector port 110 is shown in FIG. 2. The electronic device 100 includes example power budget circuitry 200. The power budget circuitry 200 dynamically adjusts power allocation to components of the electronic device 100 and the computer peripherals 102, 104, 106, 108.

The power budget circuitry 200 includes example peripheral detection circuitry 202, an example power delivery controller (PD) 204, an example clock 206, an example embedded controller (EC) 208 (or other microcontroller, microprocessor, or other logic circuitry), example machine learning circuitry 210, and an example database 212. The clock 206 can be used to track times discussed herein. The clock 206 may correspond to a system clock and be separate from the power budget circuitry 200. The database 212 can be used to store data related to the computer peripherals 102, 104, 106, 108 and other data related to characteristics and/or operation of the electronic device 100. The electronic device 100 also includes an example CPU 214 and an example battery 216. The battery 216 supplies power to be consumed by the electronic device 100 and the computer peripherals 102, 104, 106, 108. The power from the battery 2156 is allocated among component by the power budget circuitry 200. In some examples, the power budget circuitry 200 may include more or fewer components than illustrated in FIG. 2. Also, in some examples, one or more of the components of the power budget circuitry 200 may provide additional functionality for the electronic device 100.

The peripheral detection circuitry 202 detects the connection and/or disconnection of a cable and/or a computer peripheral 102, 104, 106, 108 to the connector port 110. In some examples, the peripheral detection circuitry 202 identifies which connector port 110 is coupled to the computer peripheral 102, 104, 106, 108. In addition, in some examples, the peripheral detection circuitry 102 can identify a type of the computer peripheral 102, 104, 106, 108 based on a product identification code (PID) and/or a vendor identification code (VID).

When the computer peripheral 102, 104, 106, 108 is connected to the electronic device 100, the PD 204 supplies the computer peripheral 102, 104, 106, 108 with power. Specifications of different computer peripherals may indicate that the power is to be supplied to the computer peripheral within a specific time frame. For example, a device specification may set a 275 millisecond (ms) time limit to provide power to the computer peripheral. At the same time, the EC 208 queries for the power contract of the computer peripheral 102, 104, 106, 108 so that the EC 208 can update a power level offset register, which indicates an amount of power that is offset from the CPU 214 and reserved for the computer peripherals 102, 104, 106, 108.

When the CPU 214 and one or more of the computer peripherals 102, 104, 106, 108 simultaneously draw power, the electronic device 100 operates at a high or peak power level. For example, a high power level such as Intel's PL4 is a power level or power limit at which the electronic device 100 can operate without damaging the circuitry. The performance of the CPU 214 depends on the PL4 setting. The PL4 number sets the instantaneous power the CPU 214 draws in turbo boost conditions. However, the PL4 value is limited and set according to the power capability of the battery 216 of the electronic device 100.

When the computer peripheral 102, 104, 106, 108 is connected to the electronic device 100, the EC 208 takes time to determine the final power role of the computer peripheral 102, 104, 106, 108 before the PL4 offset register can be updated with the actual contracted power. Because the computer peripheral 102, 104, 106, 108 is to be supplied with power within the specified time limit (e.g., 275 ms) after a connection is properly made, the PD 204 cannot delay providing power until the EC 208 updates the PL4 offset register with the actual contracted power.

In prior devices, the PD 204 would issue a thermal alert such as, for example, PROCHOT# to buy additional time to power the computer peripheral 102, 104, 106, 108. When a thermal alert such as PROCHOT# is asserted, power to the CPU 214 power is reduced so that power can be given immediately to the computer peripheral 102, 104, 106, 108 as needed, without the electronic device 100 exceeding the battery power. The thermal alert transitions the CPU 214 into a low frequency mode, which throttles the CPU 214 and avoids overheating. The reduction in power to the CPU 214 may cause the electronic device 100 to freeze, resulting in poor user experience while the computer peripheral 102, 104, 106, 108 is powered up. After the PL4 offset register is updated to account for power given to the computer peripheral 102, 104, 106, 108, the thermal alert (e.g., PROCHOT#) can be released or de-asserted, and the CPU 214 will have a power budget (PL4) that is less the power given to the computer peripheral 102, 104, 106, 108 (PL4 offset).

Examples disclosure herein remove the need for a thermal alert such as PROCHOT# assertion (e.g., no PROCHOT# assert occurs) by ensuring that the power budget is updated within the timing specifications. The EC 208 takes advantage of the debounce time to start updating the PL4 offset register. Debounce time is a time period after the connection of a device (e.g., one of the computer peripherals 102, 104, 106, 108) in which it is determined if the connection is a solid and/or valid connection before entering a final connected state. In some examples, the debounce time is about 200 ms. Typically, the debounce time is observed before further action is taken. However, in examples disclosed herein, the EC 208 preemptively assumes a valid connection of the computer peripheral 102, 104, 106, 108 and ignores the debounce time. During the debounce time, the EC 208 writes to or begins to write to the power level offset register based on a preemptive or assumed power contract for the computer peripheral 102, 104, 106, 108.

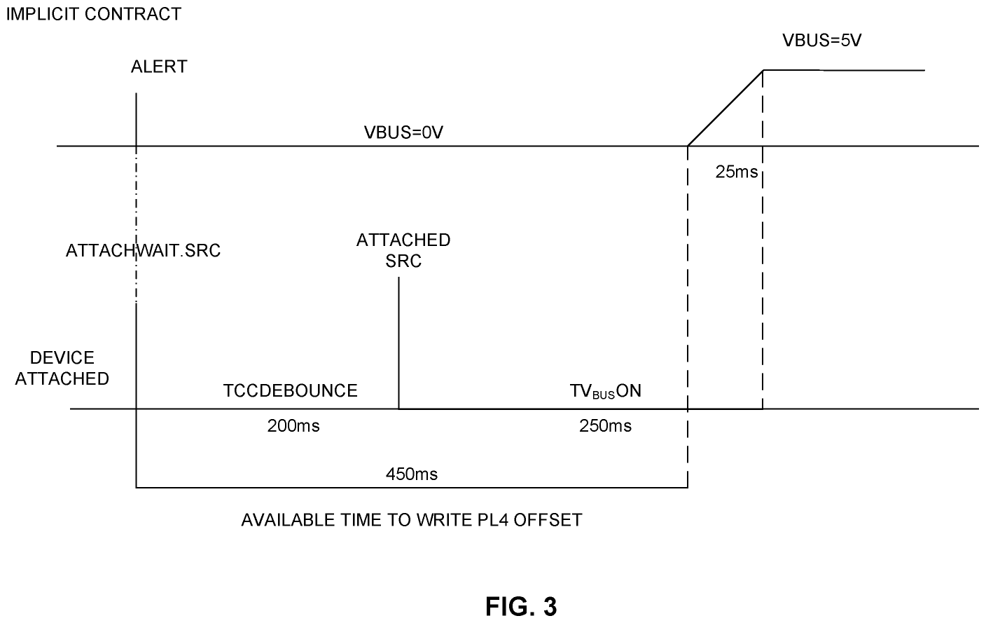

FIG. 3 illustrates a timing chart during connection of one of the computer peripherals 102, 104, 106, 108 to the electronic device 100. As shown in FIG. 3, one of the computer peripherals 102, 104, 106, 108 is attached the electronic device 100. The PD 204 asserts an alert (e.g., AttachWait.SRC) to communicate to the EC 208 that one of the computer peripherals 102, 104, 106, 108 has been attached to the electronic device 100. The EC 208 assumes a valid connection and de-asserts the alert (e.g., AttachWait.SRC) during the debounce time (e.g., tCCDebounce). In the example of FIG. 3, the debounce time is 200 ms. After the debounce time, the connection of the one of the computer peripherals 102, 104, 106, 108 is validated as indicated by the alert Attached.SRC. After the connection of the one of the computer peripherals 102, 104, 106, 108 is validated, the specified time period (e.g., TV_{BUS}ON) for powering the bus that provides power to the one of the computer peripherals 102, 104, 106, 108 starts. In the example of FIG. 3, the time to power one of the computer peripherals 102, 104, 106, 108 is 250 ms. The bus itself uses another time period to power up from zero Volts. For example, the bus may take about 25 ms to power from zero to five Volts. Thus, in the example of FIG. 3, the EC 208 has 450 ms to write the power level offset. Traditional systems that observe the full debounce time would only offer 250 ms to write the power level offset in this scenario.

In addition, in some examples, because the connection of the computer peripheral 102, 104, 106, 108 is not yet confirmed, the EC 208 cannot ascertain the actual power contract of the computer peripheral 102, 104, 106, 108. By making a pre-emptive assumption of the power needs for the computer peripheral 102, 104, 106, 108, the EC 208 does not have to wait for establishment of the actual power contract. Thus, the EC 208 budgets power by assuming a maximum power of per port without waiting for the actual power contract. In some examples, the maximum power per port is assumed based on an assumed power contract for one of the computer peripherals 102, 104, 106, 108 and additional power for the power consumed by the cable delivering power to the computer peripherals 102, 104, 106, 108. For example, a maximum power per port of 16.5 W may be assumed, which includes 15 W for V_{BUS} (for the computer peripheral) plus 1.5 W for V_{CONN} (for the cable). This power assumption by the EC 208 saves additional time. In other examples, other amounts of power may be assumed.

When the connection is complete, and the PD 204 provides power to the computer peripherals 102, 104, 106, 108, the EC 208 further adjusts the power budgeting to the actual power contract of the computer peripherals 102, 104, 106, 108. In some examples, the EC 208 adjusts the power budgeting (i.e., updated the power level offset) within or after a time threshold of, for example, one second. In other words, the EC 208 reclaims power for the CPU 214 that may have been overbudgeted to the computer peripherals 102, 104, 106, 108 when the maximum power for the computer peripherals 102, 104, 106, 108 was assumed. There is no urgency at this stage because the computer peripherals 102, 104, 106, 108 are receiving power and the CPU 214 is operating normally. The EC 208 nonetheless updates the power budget and power level offsets based on the actual contract so that the CPU 214 gains back the maximum power after adjusting for the power for the computer peripherals 102, 104, 106, 108 (e.g., Type-C power). Notably, there is no thermal alert (e.g., PROCHOT# assertion) in the example of FIG. 3.

Table 1 illustrates different events (e.g., Type-C or computer peripheral related events) in which the EC 208 regains significant amount of time to complete power allocation before V_{BUS} is supplied to the computer peripheral 102, 104, 106, 108 (e.g., Type-C device) without having to assert a thermal alert (e.g., PROCHOT#).

| Event | PROCHOT#assert |
|---|---|
| USB-C Sink device is connected (host is source) | No |
| USB-C Sink device is removed | No |
| USB-C Source device is connected (e.g., adapter) | No |
| Source requested power role swap (PRS) (e.g., | No |
| platform source swapped to sink) | |

USB-C devices represent different computer peripherals. A sink device consumes power from the V_{BUS} when attached. A source device provides power over V_{BUS} when attached.

In some examples, the machine learning circuitry 210 can learn power contracts of different ones of the computer peripherals 102, 104, 106, 108 based on history of use of the computer peripherals 102, 104, 106, 108 with the electronic device 100, and/or from the VID and/or PID of the computer peripheral 102, 104, 106, 108. Based on the machine learning, the EC 208 may budget assumed power for the computer peripheral 102, 104, 106, 108 lower than an overbudgeted maximum power and closer to the actual power contract of the computer peripheral 102, 104, 106, 108. Thus, the machine learning circuitry 210 may enable the EC 208 to reserve more power for the CPU 214 during events with the computer peripherals 102, 104, 106, 108. With more power, the CPU 214 can operate at a higher capability, which increases the user experience.

In some examples, the PD 204 withholds or stalls power from all connector ports 110 while the electronic device 100 boots up or otherwise exits a lower power mode. All power is provided to the CPU 214 to enable a faster boot. When the boot is complete, the PD 204 can release or restore power to the connector ports 110. In some examples, the peripheral detection circuitry 202 identifies which ports 110 are occupied by one of the computer peripherals 102, 104, 106, 108, and power is released to the occupied ports 110 and not to the unoccupied ports. Reserving power from the unoccupied ports 110 retains more power for the CPU 214.

FIG. 2 is a block diagram of an example implementation of the power budget circuitry 200 of the electronic device 100 FIG. 1 to dynamically allocated power among components of the electronic device 100 and the computer peripheral 102, 104, 106, 108. The power budget circuitry 200, the peripheral detection circuitry 202, the PD 204, the clock 206, the EC 208, and/or the machine learning circuitry 210 of FIG. 2 may be instantiated (e.g., creating an instance of, bring into being for any length of time, materialize, implement, etc.) by programmable circuitry such as a CPU executing first instructions. Additionally or alternatively, the power budget circuitry 200, the peripheral detection circuitry 202, the PD 204, the clock 206, the EC 208, and/or the machine learning circuitry 210 of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers.

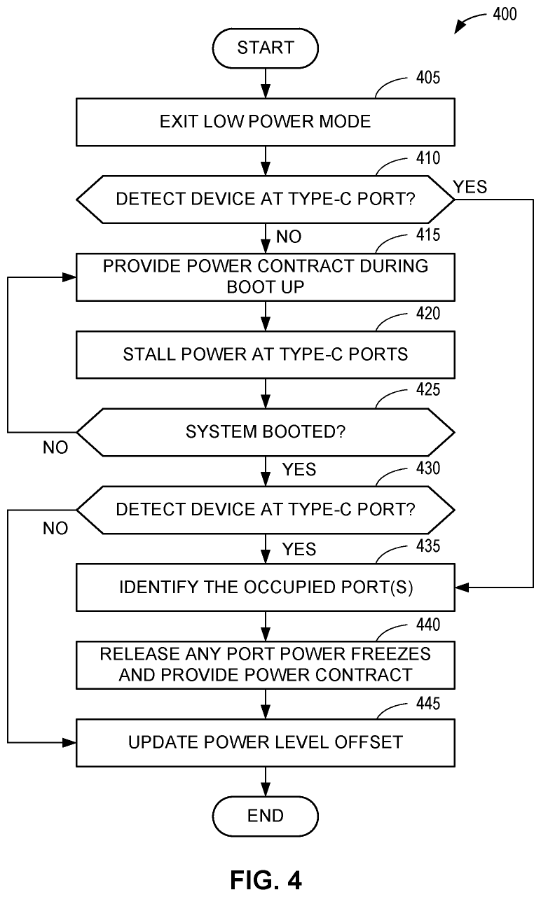

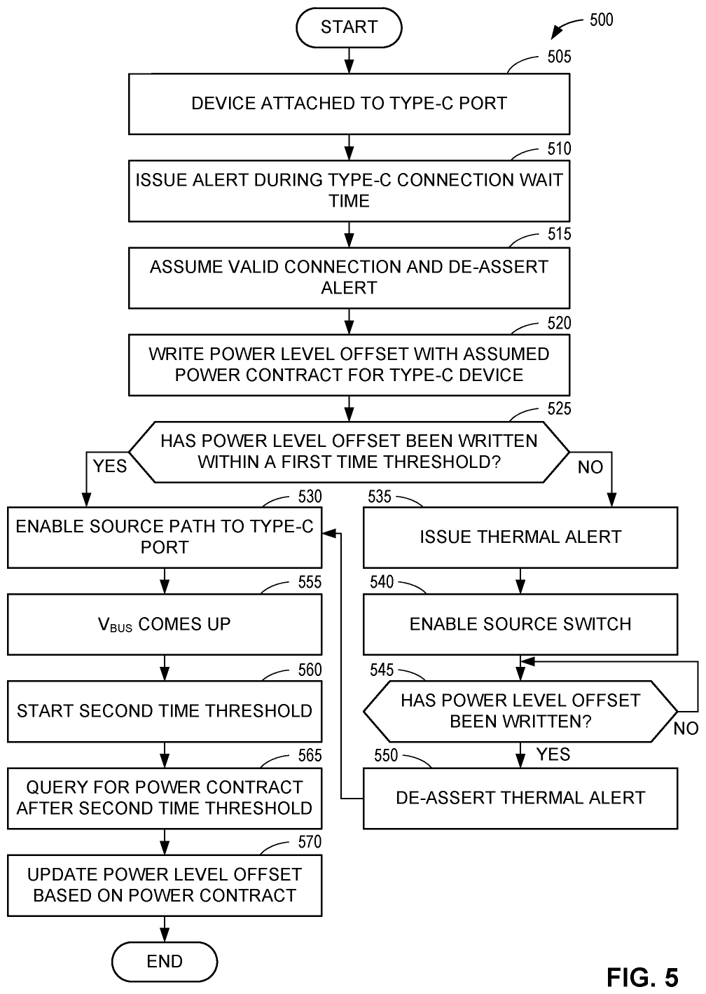

In some examples, the power budget circuitry 200 is instantiated by programmable circuitry executing power budgeting instructions and/or configured to perform operations such as those represented by the flowchart(s) of FIGS. 4 and 5.

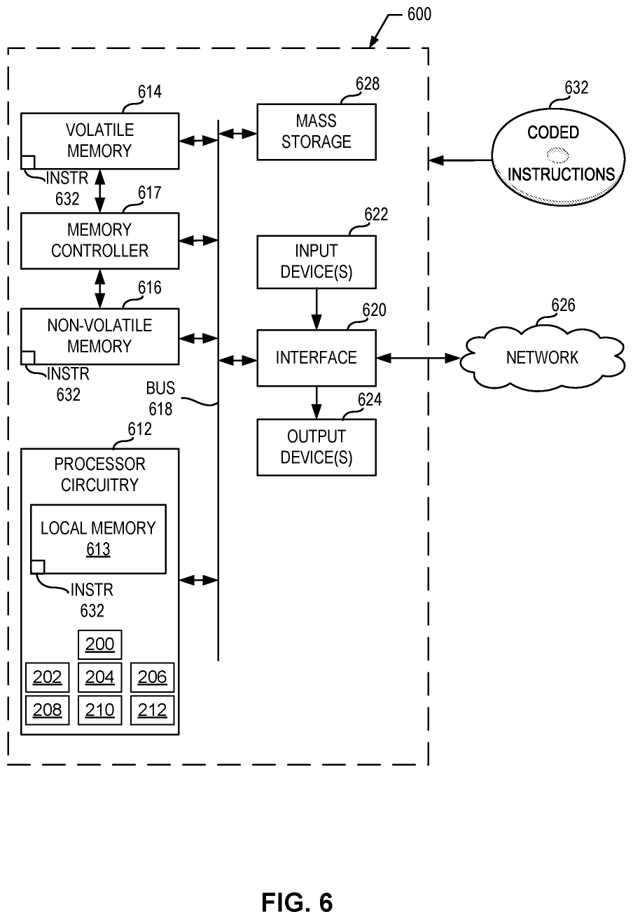

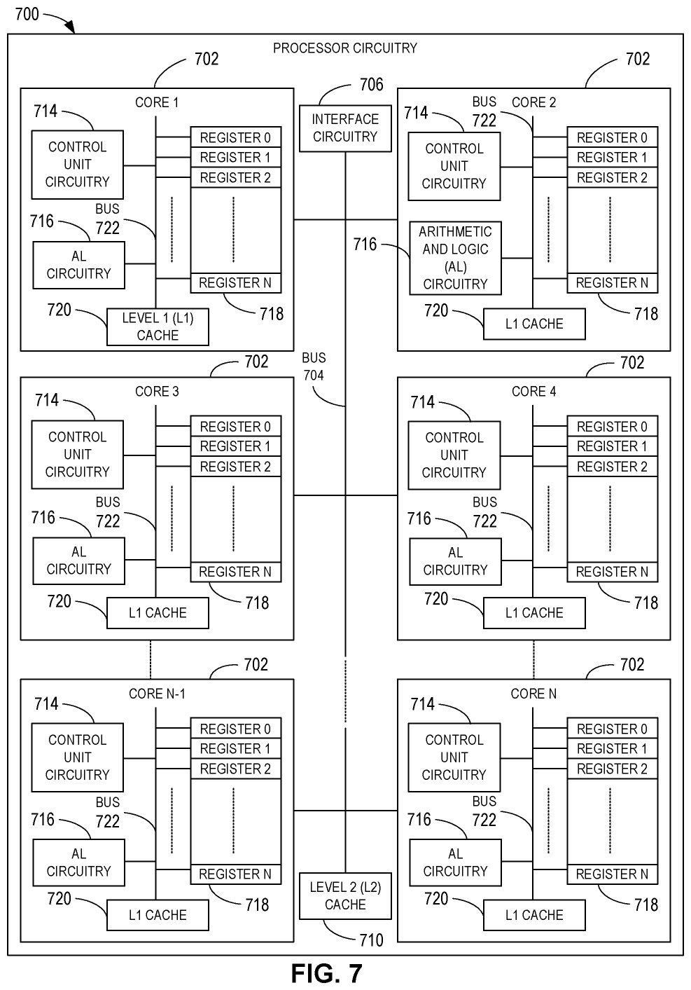

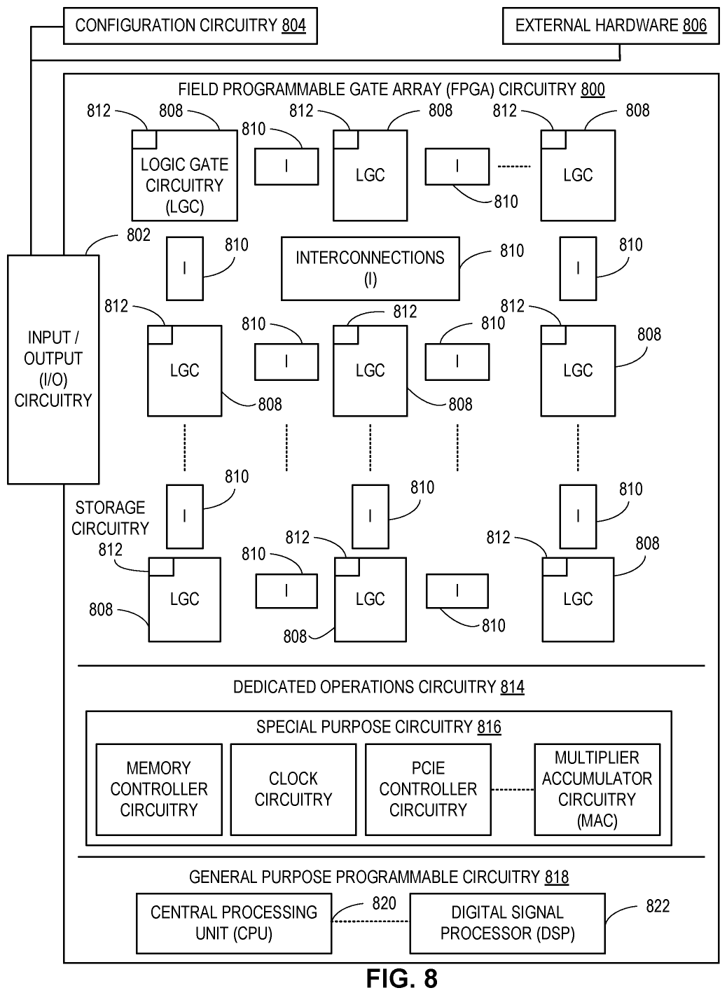

In some examples, the power budget circuitry 200 includes means for budgeting power and/or power allocation in an electronic device and/or computer peripherals. In some examples, the power budget circuitry 200 may be instantiated by programmable circuitry such as the example programmable circuitry 612 of FIG. 6. For instance, the power budget circuitry 200 may be instantiated by the example microprocessor 700 of FIG. 7 executing machine executable instructions such as those implemented by at least blocks 702, 704 of FIG. 7. In some examples, the power budget circuitry 200 may be instantiated by hardware logic circuitry, which may be implemented by an ASIC, XPU, or the FPGA circuitry 800 of FIG. 8 configured and/or structured to perform operations corresponding to the machine readable instructions. Additionally or alternatively, the power budget circuitry 200 may be instantiated by any other combination of hardware, software, and/or firmware. For example, the power budget circuitry 200 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

While an example manner of implementing the power budget circuitry 200 of FIG. 1 is illustrated in FIG. 2, one or more of the elements, processes, and/or devices illustrated in FIG. 2 may be combined, divided, re-arranged, omitted, eliminated, and/or implemented in any other way. Further, the example peripheral detection circuitry 202, the example PD 204, the example clock 206, the example EC 208, the example machine learning circuitry 210, the example database 212, and/or, more generally, the example power budget circuitry 200 of FIG. 2, may be implemented by hardware alone or by hardware in combination with software and/or firmware. Thus, for example, any of the example peripheral detection circuitry 202, the example PD 204, the example clock 206, the example EC 208, the example machine learning circuitry 210, the example database 212, and/or, more generally, the example power budget circuitry 200, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example power budget circuitry 200 of FIG. 2 may include one or more elements, processes, and/or devices in addition to, or instead of, those illustrated in FIG. 2, and/or may include more than one of any or all of the illustrated elements, processes and devices.

Flowchart(s) representative of example machine readable instructions, which may be executed by programmable circuitry to implement and/or instantiate the power budget circuitry 200 of FIG. 2 and/or representative of example operations which may be performed by programmable circuitry to implement and/or instantiate the power budget circuitry 200 of FIG. 2, are shown in FIGS. 4 and 5. The machine readable instructions may be one or more executable programs or portion(s) of one or more executable programs for execution by programmable circuitry such as the programmable circuitry 612 shown in the example processor platform 600 discussed below in connection with FIG. 6 and/or may be one or more function(s) or portion(s) of functions to be performed by the example programmable circuitry (e.g., an FPGA) discussed below in connection with FIGS. 7 and/or 8. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 4 and 5, many other methods of implementing the example power budget circuitry 200 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 4 and 5 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 4 is a flowchart representative of example machine readable instructions and/or example operations 400 that may be executed, instantiated, and/or performed by programmable circuitry to allocate or budget power among an electronic device and one or more computer peripherals during a boot operation of the electronic device. The example machine-readable instructions and/or the example operations 400 of FIG. 4 includes the electronic device exiting a low power mode (block 405). For example, the electronic device 100 may exit a low power mode such as when the electronic device 100 is booting up.

The peripheral detection circuitry 202 of the power budget circuitry 200 detects if a device (e.g., a computer peripheral such as a Type-C device) is coupled to a Type-C port (e.g., one of the connector ports 110) (block 410). If and/or when the peripheral detection circuitry 202 does not detect a device at the 4 Type-C port (block 410: NO), the PD 204 provides the power contract during boot up the device (block 415). In addition, the PD 204 stalls or freezes power at the Type-C ports (block 420). When the power is stalled at the Type-C ports, more power remains available for the CPU 214 to boot more quickly.

The EC 208 determines if the system (i.e., the electronic device 100) is booted (block 425). If and/or when the EC 208 determines that the system is not booted (block 425: NO), the example process 400 continues with the PD 204 providing the power contract during the boot up (block 415). If and/or when the EC 208 determines that the system is booted (block 425: YES), the peripheral detection circuitry 202 determines if a device (e.g., a computer peripheral such as a Type-C device) is coupled to a Type-C port (e.g., one of the connector ports 110) (block 430).

If and/or when the peripheral detection circuitry 202 determines that a device is coupled to a Type-C port (block 410:YES; and/or block 430: YES), the peripheral detection circuitry 202 identifies which of the ports 110 is occupied by a computer peripheral (block 435). The peripheral detection circuitry 202 may detect an occupied port before and/or during boot up (e.g., from block 410) and/or after boot up (e.g., from block 430). Detection of which port is occupied enables the delivery and/or allocation of power to the occupied port(s) and not to all ports including empty ports. This enables the power budget circuitry 200 to reserve more power for the CPU 214 and avoid overbudgeting power to the ports 110. The PD 204 releases any port power freezes for ports that are occupied and provides the power contract for the Type-C device (e.g., computer peripheral) coupled thereto (block 440).

In some examples, a bootup device (such as boot from USB stick) is inserted into one of the Type-C ports. In such examples, the peripheral detection circuitry 202 detects which port is occupied, and the PD 204 selectively releases power to that port, which stalling power on all other ports until the operating system boot-up is successful.

If and/or when the peripheral detection circuitry 202 determines that there are no devices coupled to a Type-C port (block 430: NO), and/or after the PD provides the power contract for any Type-C device (e.g., computer peripheral) coupled to the electronic device 100, the EC 208 updates the power level offset (block 445). Thereafter, the example process 400 of FIG. 4 ends.

FIG. 5 is a flowchart representative of example machine readable instructions and/or example operations 500 that may be executed, instantiated, and/or performed by programmable circuitry to allocate or budget power among an electronic device and one or more computer peripherals. The example machine-readable instructions and/or the example operations 500 of FIG. 5 includes a device (e.g., a computer peripheral and/or other type of Type-C device) being attached to a Type-C port (e.g., one of the connector ports 110) (block 505). In other examples the process 500 may begin with another type of Type-C or other computer peripheral event that would cause or warrant a reallocation or rebudgeting of power among the electronic device 100 and/or the computer peripherals 102, 104, 106, 108 such as, for example, a detachment of a computer peripheral, role swapping, etc.

The PD 204 issues an alert (e.g., AttachWait.Src) or other communication indicative of the connection of the device (e.g., a computer peripheral and/or other type of Type-C device) to the Type-C port (or other event) during a Type-C connection wait time (e.g., a debounce time) (block 510). The EC 208 assumes a valid connection of the device (e.g., a computer peripheral and/or other type of Type-C device) and de-asserts the alert from the PD 204 (block 515).

The EC 208 write the power level offset with an assumed power level contract for the Type-C device (or other computer peripheral) coupled to the electronic device 100 (block 520). In some examples, the EC 208 writes the power level offset during the connection wait (debounce) time.

Using the clock 206, the PD 204 starts a timer related to a first time threshold and the power budget circuitry 200 determines if the EC 208 has written the power level offset within the first time threshold (block 525). If and/or when the power budget circuitry 200 determines that the EC 208 has written the power level offset within the first time threshold (block 525: YES), the EC 208 enables a source path (e.g., a bit called SRC_EN defined by the PD 204) to the Type-C port (block 530). In some examples, the EC 208 sets the SRC_EN but to 1, which indicates that the writing and/or updating of the power level offset by the EC 208 was successful. In some examples, the first time threshold is adjustable.

If and/or when the power budget circuitry 200 determines that the EC 208 has not written the power level offset within the first time threshold (block 525: NO), the PD 204 issues a thermal alert (e.g., PROCHOT#) (block 535). In some examples, the PD 204 enables a source switch (block 540). A source switch may be used to reduce stress on the battery 216. The EC 208 may read the thermal alert and clear the thermal alert while the EC 208 continues to write the power level offset. Nonetheless, the PD 204 continues to assert the thermal alert until the power level offset is successfully written. The example process 500 includes the power budget circuitry 200 determining if the power level offset has been written (block 545). If and/or when the power budget circuitry 200 determines that the power level offset has not been written (block 545: NO), the example process 500 continues in a loop with the EC 208 attempting to write the power lever offset and the PD 204 issuing the thermal alert.

If and/or when the power budget circuitry 200 determines that the power level offset has been written (block 545: YES), the PD 204 de-asserts the thermal alert (block 550), and the EC enables the source path to the Type-C port (block 530). As disclosed above, in some examples, enabling the source path includes the EC 208 setting the SRC_EN but to 1, which indicates that the writing and/or updating of the power level offset by the EC 208 was successful.

With the source path enabled, the VBUS comes up or draws power (block 555). Thus, power is provided to the computer peripheral or Type-C device. Using the clock 206, the EC 208 starts a timer related to a second time threshold (block 560). The EC 208 queries the PD 204 for the power contract related to the attached computer peripheral or Type-C device after the second time threshold (block 565). In some examples, the second time threshold is about one second. In other examples, the second time threshold is about 3-4 seconds. In some examples, the second time threshold is adjustable. The EC 208 updates the power level offset based on the power contract (block 570), and the example power budgeting process 500 ends.

In some examples, if the EC 208 fails to successfully write and/or update the power level offset within a threshold amount of time, the PD 204 will disable the source port (e.g., the connector port 110).

Examples disclosed herein may be used during a booting of the electronic device 100 and/or during any exiting of a low power state. In some examples, upon entering a low power state, a power level offset programmed into the electronic device 100 (e.g., into the CPU 214) is erased. Upon exiting the low power state, the power level offset is to be re-programmed so that the power budget circuitry 200 can effectively allocate power from the battery 216. In some examples, a basic input/output system (BIOS) of the electronic device 100 (or other program on the CPU 214 sends a command to the EC 208 to indicate the point of restoration or reprogramming of the power level offset. In some examples, the reprogramming of the power level offset is to occur when the CPU 214 is ready and before an event that may trigger a high power state (e.g., a turbo state) so that the EC 208 has sufficient time to reprogram the power level offset.

FIG. 6 is a block diagram of an example programmable circuitry platform 600 structured to execute and/or instantiate the example machine-readable instructions and/or the example operations of FIGS. 4 and 5 to implement the power budget circuitry 200 of FIG. 2. The programmable circuitry platform 600 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 600 of the illustrated example includes programmable circuitry 612. The programmable circuitry 612 of the illustrated example is hardware. For example, the programmable circuitry 612 can be implemented by one or more integrated circuits, logic circuits, FPGAs, microprocessors, CPUs, GPUs, DSPs, and/or microcontrollers from any desired family or manufacturer. The programmable circuitry 612 may be implemented by one or more semiconductor based (e.g., silicon based) devices. In this example, the programmable circuitry 612 implements the power budget circuitry 200, the peripheral detection circuitry 202, the PD 204, the clock 206, the EC 208, and the machine learning circuitry 210.

The programmable circuitry 612 of the illustrated example includes a local memory 613 (e.g., a cache, registers, etc.). The programmable circuitry 612 of the illustrated example is in communication with main memory 614, 616, which includes a volatile memory 614 and a non-volatile memory 616, by a bus 618. The volatile memory 614 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 616 may be implemented by flash memory and/or any other desired type of memory device. Access to the main memory 614, 616 of the illustrated example is controlled by a memory controller 617. In some examples, the memory controller 617 may be implemented by one or more integrated circuits, logic circuits, microcontrollers from any desired family or manufacturer, or any other type of circuitry to manage the flow of data going to and from the main memory 614, 616.

The programmable circuitry platform 600 of the illustrated example also includes interface circuitry 620. The interface circuitry 620 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 622 are connected to the interface circuitry 620. The input device(s) 622 permit(s) a user (e.g., a human user, a machine user, etc.) to enter data and/or commands into the programmable circuitry 612. The input device(s) 622 can be implemented by, for example, an audio sensor, a microphone, a camera (still or video), a keyboard, a button, a mouse, a touchscreen, a trackpad, a trackball, an isopoint device, and/or a voice recognition system.

One or more output devices 624 are also connected to the interface circuitry 620 of the illustrated example. The output device(s) 624 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 620 of the illustrated example, thus, typically includes a graphics driver card, a graphics driver chip, and/or graphics processor circuitry such as a GPU.

The interface circuitry 620 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 626. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 600 of the illustrated example also includes one or more mass storage discs or devices 628 to store firmware, software, and/or data. Examples of such mass storage discs or devices 628 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 632, which may be implemented by the machine readable instructions of FIGS. 4 and 5, may be stored in the mass storage device 628, in the volatile memory 614, in the non-volatile memory 616, and/or on at least one non-transitory computer readable storage medium such as a CD or DVD which may be removable.

FIG. 7 is a block diagram of an example implementation of the programmable circuitry 612 of FIG. 6. In this example, the programmable circuitry 612 of FIG. 6 is implemented by a microprocessor 700. For example, the microprocessor 700 may be a general-purpose microprocessor (e.g., general-purpose microprocessor circuitry). The microprocessor 700 executes some or all of the machine-readable instructions of the flowcharts of FIGS. 4 and 5 to effectively instantiate the circuitry of FIG. 2 as logic circuits to perform operations corresponding to those machine readable instructions. In some such examples, the circuitry of FIG. 2 is instantiated by the hardware circuits of the microprocessor 700 in combination with the machine-readable instructions. For example, the microprocessor 700 may be implemented by multi-core hardware circuitry such as a CPU, a DSP, a GPU, an XPU, etc. Although it may include any number of example cores 702 (e.g., 1 core), the microprocessor 700 of this example is a multi-core semiconductor device including N cores. The cores 702 of the microprocessor 700 may operate independently or may cooperate to execute machine readable instructions. For example, machine code corresponding to a firmware program, an embedded software program, or a software program may be executed by one of the cores 702 or may be executed by multiple ones of the cores 702 at the same or different times. In some examples, the machine code corresponding to the firmware program, the embedded software program, or the software program is split into threads and executed in parallel by two or more of the cores 702. The software program may correspond to a portion or all of the machine readable instructions and/or operations represented by the flowcharts of FIGS. 4 and 5.

The cores 702 may communicate by a first example bus 704. In some examples, the first bus 704 may be implemented by a communication bus to effectuate communication associated with one(s) of the cores 702. For example, the first bus 704 may be implemented by at least one of an Inter-Integrated Circuit (I2C) bus, a Serial Peripheral Interface (SPI) bus, a PCI bus, or a PCIe bus. Additionally or alternatively, the first bus 704 may be implemented by any other type of computing or electrical bus. The cores 702 may obtain data, instructions, and/or signals from one or more external devices by example interface circuitry 706. The cores 702 may output data, instructions, and/or signals to the one or more external devices by the interface circuitry 706. Although the cores 702 of this example include example local memory 720 (e.g., Level 1 (L1) cache that may be split into an L1 data cache and an L1 instruction cache), the microprocessor 700 also includes example shared memory 710 that may be shared by the cores (e.g., Level 2 (L2 cache)) for high-speed access to data and/or instructions. Data and/or instructions may be transferred (e.g., shared) by writing to and/or reading from the shared memory 710. The local memory 720 of each of the cores 702 and the shared memory 710 may be part of a hierarchy of storage devices including multiple levels of cache memory and the main memory (e.g., the main memory 614, 616 of FIG. 6). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 702 may be referred to as a CPU, DSP, GPU, etc., or any other type of hardware circuitry. Each core 702 includes control unit circuitry 714, arithmetic and logic (AL) circuitry (sometimes referred to as an ALU) 716, a plurality of registers 718, the local memory 720, and a second example bus 722. Other structures may be present. For example, each core 702 may include vector unit circuitry, single instruction multiple data (SIMD) unit circuitry, load/store unit (LSU) circuitry, branch/jump unit circuitry, floating-point unit (FPU) circuitry, etc. The control unit circuitry 714 includes semiconductor-based circuits structured to control (e.g., coordinate) data movement within the corresponding core 702. The AL circuitry 716 includes semiconductor-based circuits structured to perform one or more mathematic and/or logic operations on the data within the corresponding core 702. The AL circuitry 716 of some examples performs integer based operations. In other examples, the AL circuitry 716 also performs floating-point operations. In yet other examples, the AL circuitry 716 may include first AL circuitry that performs integer-based operations and second AL circuitry that performs floating-point operations. In some examples, the AL circuitry 716 may be referred to as an Arithmetic Logic Unit (ALU).

The registers 718 are semiconductor-based structures to store data and/or instructions such as results of one or more of the operations performed by the AL circuitry 716 of the corresponding core 702. For example, the registers 718 may include vector register(s), SIMD register(s), general-purpose register(s), flag register(s), segment register(s), machine-specific register(s), instruction pointer register(s), control register(s), debug register(s), memory management register(s), machine check register(s), etc. The registers 718 may be arranged in a bank as shown in FIG. 7. Alternatively, the registers 718 may be organized in any other arrangement, format, or structure, such as by being distributed throughout the core 702 to shorten access time. The second bus 722 may be implemented by at least one of an I2C bus, a SPI bus, a PCI bus, or a PCIe bus.

Each core 702 and/or, more generally, the microprocessor 700 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 700 is a semiconductor device fabricated to include many transistors interconnected to implement the structures described above in one or more integrated circuits (ICs) contained in one or more packages.

The microprocessor 700 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 700, in the same chip package as the microprocessor 700 and/or in one or more separate packages from the microprocessor 700.

FIG. 8 is a block diagram of another example implementation of the programmable circuitry 612 of FIG. 6. In this example, the programmable circuitry 612 is implemented by FPGA circuitry 800. For example, the FPGA circuitry 800 may be implemented by an FPGA. The FPGA circuitry 800 can be used, for example, to perform operations that could otherwise be performed by the example microprocessor 700 of FIG. 7 executing corresponding machine readable instructions. However, once configured, the FPGA circuitry 800 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 700 of FIG. 7 described above (which is a general purpose device that may be programmed to execute some or all of the machine readable instructions represented by the flowchart(s) of FIGS. 4 and 5 but whose interconnections and logic circuitry are fixed once fabricated), the FPGA circuitry 800 of the example of FIG. 8 includes interconnections and logic circuitry that may be configured, structured, programmed, and/or interconnected in different ways after fabrication to instantiate, for example, some or all of the operations/functions corresponding to the machine readable instructions represented by the flowchart(s) of FIGS. 4 and 5. In particular, the FPGA circuitry 800 may be thought of as an array of logic gates, interconnections, and switches. The switches can be programmed to change how the logic gates are interconnected by the interconnections, effectively forming one or more dedicated logic circuits (unless and until the FPGA circuitry 800 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 4 and 5. As such, the FPGA circuitry 800 may be configured and/or structured to effectively instantiate some or all of the operations/functions corresponding to the machine readable instructions of the flowchart(s) of FIGS. 4 and 5 as dedicated logic circuits to perform the operations/functions corresponding to those software instructions in a dedicated manner analogous to an ASIC. Therefore, the FPGA circuitry 800 may perform the operations/functions corresponding to the some or all of the machine readable instructions of FIGS. 4 and 5 faster than the general-purpose microprocessor can execute the same.

In the example of FIG. 8, the FPGA circuitry 800 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 800 of FIG. 8 may access and/or load the binary file to cause the FPGA circuitry 800 of FIG. 8 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 800 of FIG. 8 to cause configuration and/or structuring of the FPGA circuitry 800 of FIG. 8, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 800 of FIG. 8 may access and/or load the binary file to cause the FPGA circuitry 800 of FIG. 8 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 800 of FIG. 8 to cause configuration and/or structuring of the FPGA circuitry 800 of FIG. 8, or portion(s) thereof.

The FPGA circuitry 800 of FIG. 8, includes example input/output (I/O) circuitry 802 to obtain and/or output data to/from example configuration circuitry 804 and/or external hardware 806. For example, the configuration circuitry 804 may be implemented by interface circuitry that may obtain a binary file, which may be implemented by a bit stream, data, and/or machine-readable instructions, to configure the FPGA circuitry 800, or portion(s) thereof. In some such examples, the configuration circuitry 804 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 806 may be implemented by external hardware circuitry. For example, the external hardware 806 may be implemented by the microprocessor 700 of FIG. 7.

The FPGA circuitry 800 also includes an array of example logic gate circuitry 808, a plurality of example configurable interconnections 810, and example storage circuitry 812. The logic gate circuitry 808 and the configurable interconnections 810 are configurable to instantiate one or more operations/functions that may correspond to at least some of the machine readable instructions of FIGS. 4 and 5 and/or other desired operations. The logic gate circuitry 808 shown in FIG. 8 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 808 to enable configuration of the electrical structures and/or the logic gates to form circuits to perform desired operations/functions. The logic gate circuitry 808 may include other electrical structures such as look-up tables (LUTs), registers (e.g., flip-flops or latches), multiplexers, etc.

The configurable interconnections 810 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 808 to program desired logic circuits.

The storage circuitry 812 of the illustrated example is structured to store result(s) of the one or more of the operations performed by corresponding logic gates. The storage circuitry 812 may be implemented by registers or the like. In the illustrated example, the storage circuitry 812 is distributed amongst the logic gate circuitry 808 to facilitate access and increase execution speed.

The example FPGA circuitry 800 of FIG. 8 also includes example dedicated operations circuitry 814. In this example, the dedicated operations circuitry 814 includes special purpose circuitry 816 that may be invoked to implement commonly used functions to avoid the need to program those functions in the field. Examples of such special purpose circuitry 816 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 800 may also include example general purpose programmable circuitry 818 such as an example CPU 820 and/or an example DSP 822. Other general purpose programmable circuitry 818 may additionally or alternatively be present such as a GPU, an XPU, etc., that can be programmed to perform other operations.

Although FIGS. 7 and 8 illustrate two example implementations of the programmable circuitry 612 of FIG. 6, many other approaches are contemplated. For example, FPGA circuitry may include an on-board CPU, such as one or more of the example CPU 820 of FIG. 7. Therefore, the programmable circuitry 612 of FIG. 6 may additionally be implemented by combining at least the example microprocessor 700 of FIG. 7 and the example FPGA circuitry 800 of FIG. 8. In some such hybrid examples, one or more cores 702 of FIG. 7 may execute a first portion of the machine readable instructions represented by the flowchart(s) of FIGS. 4 and 5 to perform first operation(s)/function(s), the FPGA circuitry 800 of FIG. 8 may be configured and/or structured to perform second operation(s)/function(s) corresponding to a second portion of the machine readable instructions represented by the flowcharts of FIGS. 4 and 5, and/or an ASIC may be configured and/or structured to perform third operation(s)/function(s) corresponding to a third portion of the machine readable instructions represented by the flowcharts of FIGS. 4 and 5.

It should be understood that some or all of the circuitry of FIG. 2 may, thus, be instantiated at the same or different times. For example, same and/or different portion(s) of the microprocessor 700 of FIG. 7 may be programmed to execute portion(s) of machine-readable instructions at the same and/or different times. In some examples, same and/or different portion(s) of the FPGA circuitry 800 of FIG. 8 may be configured and/or structured to perform operations/functions corresponding to portion(s) of machine-readable instructions at the same and/or different times.

In some examples, some or all of the circuitry of FIG. 2 may be instantiated, for example, in one or more threads executing concurrently and/or in series. For example, the microprocessor 700 of FIG. 7 may execute machine readable instructions in one or more threads executing concurrently and/or in series. In some examples, the FPGA circuitry 800 of FIG. 8 may be configured and/or structured to carry out operations/functions concurrently and/or in series. Moreover, in some examples, some or all of the circuitry of FIG. 2 may be implemented within one or more virtual machines and/or containers executing on the microprocessor 700 of FIG. 7.

In some examples, the programmable circuitry 612 of FIG. 6 may be in one or more packages. For example, the microprocessor 700 of FIG. 7 and/or the FPGA circuitry 800 of FIG. 8 may be in one or more packages. In some examples, an XPU may be implemented by the programmable circuitry 612 of FIG. 6, which may be in one or more packages. For example, the XPU may include a CPU (e.g., the microprocessor 700 of FIG. 7, the CPU 820 of FIG. 8, etc.) in one package, a DSP (e.g., the DSP 822 of FIG. 8) in another package, a GPU in yet another package, and an FPGA (e.g., the FPGA circuitry 800 of FIG. 8) in still yet another package.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that allow for dynamic peak power budgeting without a thermal alert (e.g., PROCHOT# assertion) during Type-C events and/or other events related to power allocation to computer peripherals. This is accomplished by the power budget circuitry 200 by preemptively assuming that a connection with a computer peripheral is valid and ignoring the debounce time. Examples disclosed herein provide the EC 208 with additional time (e.g., 200 ms) to write to the power level offset register. The EC 208 also has additional time from VBUS delay (e.g., 250 ms) to complete the write. In addition, in some examples, the EC 208 also updates the power level offset register with an assumed or preemptive maximum power for the computer peripheral, and later the EC 208 queries the PD 204 for actual power contract value for finer adjustments to the power level offset.

Examples disclosed herein allow for a seamless transition after a booting event or computer peripheral event without forcing the CPU 214 to throttle. Thus, these examples also provide a good user experience when Type-C devices (and/or other computer peripherals) are attached or detached and/or during power events like an initial PD contract, a contract change, a power role swap, and/or a fast role swap.

In some examples, there may be a reduction in one general purpose input/output because the thermal alert (e.g., PROCHOT# signal) can be removed from the PD 204. In addition, the power allocation and performance benefits of examples herein can be realized without additional hardware cost.

Thus, disclosed systems, apparatus, articles of manufacture, and methods improve the efficiency of using a computing device by dynamically budgeting power while avoiding thermal alerts. Disclosed systems, apparatus, articles of manufacture, and methods are accordingly directed to one or more improvement(s) in the operation of a machine such as a computer or other electronic and/or mechanical device.

Systems, apparatus, articles of manufacture, and methods are disclosed for power budgeting for computer peripherals with electronic devices. Example 1 includes an apparatus to budget power in an electronic device that includes interface circuitry; machine readable instructions; and programmable circuitry to at least one of instantiate or execute the machine readable instructions to: detect a Type-C event associated with a computer peripheral; write a power level offset based on an assumed power contract for the computer peripheral during debounce time; obtain an actual power contract for the computer peripheral; and adjust the power level offset based on the actual power contract.

Example 2 includes the apparatus of Example 1, wherein the programmable circuitry is to cause power delivery to a CPU of the electronic device and the computer peripheral at a same time without asserting a thermal alert.

Example 3 includes the apparatus of any of Examples 1 or 2, wherein the programmable circuitry is to cause power delivery to a CPU of the electronic device and the computer peripheral at a same time while the CPU operates outside of a low frequency mode.

Example 4 includes the apparatus of any of Examples 1-3, wherein the assumed power contract includes a first amount of power for the computer peripheral and a second amount of power for a cable coupling the computer peripheral and the electronic device.

Example 5 includes the apparatus of any of Examples 1-4, wherein the programmable circuitry includes a microcontroller.

Example 6 includes the apparatus of any of Examples 1-5, wherein the programmable circuitry is to adjust the power level offset after the computer peripheral has power.

Example 7 includes the apparatus of any of Examples 1-6, wherein the electronic device includes a plurality of Type-C ports, and the programmable circuitry is to is to stall power to the Type-C ports.

Example 8 includes the apparatus of Example 7, wherein the programmable circuitry is to: identify which of Type-C ports is occupied by the computer peripheral based on the Type-C event; and subsequently release power to the occupied Type-C port.

Example 9 includes the apparatus of any of Examples 1-8, wherein the Type-C event is a power role swap.

Example 10 includes the apparatus of any of Examples 1-9, wherein the Type-C event is an attachment of the computer peripheral to the electronic device and the programmable circuitry includes a microcontroller.

Example 11 includes the apparatus of any of Examples 1-10, wherein the programmable circuitry is to set the assumed power contract based on an identification of the computer peripheral.

Example 12 includes a non-transitory machine readable storage medium that includes instructions to cause programmable circuitry of an electronic device to at least: detect a Type-C event associated with a computer peripheral; write a power level offset based on an assumed power contract for the computer peripheral before a connection of the computer peripheral is validated; obtain an actual power contract for the computer peripheral; and adjust the power level offset based on the actual power contract.

Example 13 includes the storage medium of Example 12, wherein the instructions cause the programmable circuitry to enable power delivery to a CPU of the electronic device and the computer peripheral without asserting a thermal alert.

Example 14 includes the storage medium of Example 13, wherein the instructions cause the programmable circuitry to enable the power delivery to the CPU and the computer peripheral at the same time.

Example 15 includes the storage medium of any of Examples 12-14, wherein the instructions cause the programmable circuitry to enable power delivery to a CPU of the electronic device and the computer peripheral at a same time while the CPU operates outside of a low frequency mode.

Example 16 includes the storage medium of any of Examples 12-15, wherein the assumed power contract includes a first amount of power for the computer peripheral and a second amount of power for a bus coupling the computer peripheral and the electronic device.

Example 17 includes the storage medium of any of Examples 12-16, wherein the instructions cause the programmable circuitry to adjust the power level offset after the computer peripheral has power.

Example 18 includes the storage medium of any of Examples 12-17, wherein the electronic device includes a plurality of Type-C ports, and the instructions cause the programmable circuitry to stall power to the Type-C ports.

Example 19 includes the storage medium of Example 18, wherein the instructions cause the programmable circuitry to: identify which of Type-C ports is occupied by the computer peripheral based on the Type-C event; and release power to the occupied Type-C port

Example 20 includes the storage medium of any of Examples 12-19, wherein the instructions cause the programmable circuitry to set the assumed power contract based on an identification of the computer peripheral.

Example 21 includes a method to budget power in an electronic device for computer peripherals, where the method includes detecting a Type-C event associated with a computer peripheral; writing a power level offset based on an assumed power contract for the computer peripheral before a connection of the computer peripheral is validated; obtaining an actual power contract for the computer peripheral; and adjusting the power level offset based on the actual power contract.

Example 22 includes the method of Example 21, further including enabling power delivery to a CPU of the electronic device and the computer peripheral without asserting a thermal alert.

Example 23 includes the method of Example 22, wherein the enabling of the power delivery to the CPU and the computer peripheral is to occur at the same time.

Example 24 includes the method of any of Examples 21-23, further including enabling power delivery to a CPU of the electronic device and the computer peripheral at a same time while the CPU operates outside of a low frequency mode.

Example 25 includes the method of any of Examples 21-24, wherein the assumed power contract includes a first amount of power for the computer peripheral and a second amount of power for a bus coupling the computer peripheral and the electronic device.

Example 26 includes the method of any of Examples 21-25, further including adjusting the power level offset after the computer peripheral has power.

Example 27 includes the method of any of Examples 21-26, wherein the electronic device includes a plurality of Type-C ports, and the method further includes stalling power to the Type-C ports.

Example 28 includes the method of Example 27, further including identifying which of Type-C ports is occupied by the computer peripheral based on the Type-C event; and releasing power to the occupied Type-C port

Example 29 includes the method of any of Examples 21-28, further including setting the assumed power contract based on an identification of the computer peripheral.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus to budget power in an electronic device, the apparatus comprising:
interface circuitry;
machine readable instructions; and
programmable circuitry to at least one of instantiate or execute the machine readable instructions to:
detect a Type-C event associated with a computer peripheral;
write a power level offset based on an assumed power contract for the computer peripheral during debounce time;
obtain an actual power contract for the computer peripheral; and
adjust the power level offset based on the actual power contract.

2. The apparatus of claim 1, wherein the programmable circuitry is to cause power delivery to a central processing unit of the electronic device and the computer peripheral at a same time without asserting a thermal alert.

3. The apparatus of claim 1, wherein the programmable circuitry is to cause power delivery to a central processing unit (CPU) of the electronic device and the computer peripheral at a same time while the CPU operates outside of a low frequency mode.

4. The apparatus of claim 1, wherein the assumed power contract includes a first amount of power for the computer peripheral and a second amount of power for a cable coupling the computer peripheral and the electronic device.

5. The apparatus of claim 1, wherein the programmable circuitry includes a microcontroller.

6. The apparatus of claim 1, wherein the programmable circuitry is to adjust the power level offset after the computer peripheral has power.

7. The apparatus of claim 1, wherein the electronic device includes a plurality of Type-C ports, and the programmable circuitry is to is to stall power to the Type-C ports.

8. The apparatus of claim 7, wherein the programmable circuitry is to:
identify which of Type-C ports is occupied by the computer peripheral based on the Type-C event; and
subsequently release power to the occupied Type-C port.

9. The apparatus of claim 1, wherein the Type-C event is a power role swap.

10. The apparatus of claim 1, wherein the Type-C event is an attachment of the computer peripheral to the electronic device and the programmable circuitry includes a microcontroller.

11. The apparatus of claim 1, wherein the programmable circuitry is to set the assumed power contract based on an identification of the computer peripheral.

12. A non-transitory machine readable storage medium comprising instructions to cause programmable circuitry of an electronic device to at least:
detect a Type-C event associated with a computer peripheral;
write a power level offset based on an assumed power contract for the computer peripheral before a connection of the computer peripheral is validated;
obtain an actual power contract for the computer peripheral; and
adjust the power level offset based on the actual power contract.

13. The storage medium of claim 12, wherein the instructions cause the programmable circuitry to enable power delivery to a central processing unit of the electronic device and the computer peripheral without asserting a thermal alert.

14. The storage medium of claim 13, wherein the instructions cause the programmable circuitry to enable the power delivery to the central processing unit and the computer peripheral at the same time.

15. The storage medium of claim 12, wherein the instructions cause the programmable circuitry to enable power delivery to a central processing unit (CPU) of the electronic device and the computer peripheral at a same time while the CPU operates outside of a low frequency mode.

16. The storage medium of claim 12, wherein the assumed power contract includes a first amount of power for the computer peripheral and a second amount of power for a bus coupling the computer peripheral and the electronic device.

17. The storage medium of claim 12, wherein the instructions cause the programmable circuitry to adjust the power level offset after the computer peripheral has power.

18. The storage medium of claim 12, wherein the electronic device includes a plurality of Type-C ports, and the instructions cause the programmable circuitry to stall power to the Type-C ports.

19. The storage medium of claim 18, wherein the instructions cause the programmable circuitry to:
identify which of Type-C ports is occupied by the computer peripheral based on the Type-C event; and
release power to the occupied Type-C port.

20. The storage medium of claim 12, wherein the instructions cause the programmable circuitry to set the assumed power contract based on an identification of the computer peripheral.
